(19) United States
(12) Patent Application Publication
(10) Pub. No.: US 2011/0146502 A1
(43) Pub. Date: Jun. 23, 2011

(54) UNIVERSAL BAKING MOLD

(76) Inventor: Jeffrey Warren Mansur, Santa Clara, CA (US)

(21) Appl. No.: 12/645,756

(22) Filed: Dec. 23, 2009

(51) Int. Cl. A23P 1/00

(52) U.S. Cl. 99/426

(57) ABSTRACT

A modular mold for containing and baking a food product in an oven assembled by detachably interconnecting modular wall segments having endwise cylindrically nesting, rotationally free interlock regions. The modular wall segments are joined to form a mold of desired shape for food product. Magnets in the nested interlock regions serve to prevent slipping against a surface upon which the modular mold is supported.

### TECHNICAL FIELD

The present invention relates generally to apparatus used for baking a food product. More specifically, the present invention relates to a modularly assembled baking mold.

### BACKGROUND

Baking pans, which are essentially molds, are designed to contain a food product while the food product is baked. The pans and molds come in a wide assortment of shapes and sizes. There are round pans, square pans, rectangular pans, diamond shaped pans, odd shaped specialty pans, etc., and each type of pan may come in numerous sizes. The number of the various types of pans that may be used for baking is practically endless.

Not only is a separate pan needed for every shape that is desired but separate pans for each size of the shape are also needed. For example, round pans with different diameters are commonly used. These different diameters may range from four inches to twenty inches or more. Similarly, square or rectangular pans may be needed with varying sizes and dimensions.

These varying size and shape requirements require amassing a large inventory of different pan shapes and sizes. If a baking pan is not owned for a required shape or size then a new baking pan must be purchased and kept in inventory. This requires not only a large expense to acquire the inventory but also a large amount of storage space in which to keep the inventory.

Bakers need implements to contain a food product while the food product is baking which are less expensive, meet the requirements for numerous shapes and sizes, and require a minimum of storage space. An object of the invention is to reduce the expense and storage space requirements necessary to maintain such a large inventory of differently sized and shaped baking pans.

### SUMMARY

The above object has been met with modular molds that may be assembled in different shapes and sizes by using modular wall segments, to contain a food product while the food product is baking. Modular wall segments are detachably interconnected to form the modular molds by using interlocks. Each modular wall segment has a wall section, and two interlocks, a hollow inner cylindrical interlock and a hollow outer cylindrical interlock. The cylindrical interlocks are configured so the inner cylindrical interlock of a first modular wall segment may be detachably inserted into the outer cylindrical interlock of a second modular wall segment and provide at least some rotational freedom between the first and second modular wall segments.

The modular wall segments may also have slippage-retarding and containment structures. The slippage-retarding structures impede the modular mold from slipping on a surface upon which the modular mold is positioned. The use of magnets in the interlocks anchor the wall segments to an underlying ferromagnetic pan. The anchored wall segments contain baking food product in the assembled modular mold.

### BRIEF DESCRIPTION OF THE DRAWINGS

FIG. 1 is a perspective view showing a round modular mold assembled from modular segments positioned on a planar baking surface in accordance with the present invention.

FIG. 2A is a perspective view showing a quarter round modular wall segment of the type illustrated in FIG. 1 with an inner cylindrical interlock and an outer cylindrical interlock.

FIG. 2B is a perspective view of a nonstick silicone baking member that may be applied to the wall section of the quarter round modular segment of FIG. 2A.

FIG. 2C is a perspective view of a nonstick silicone baking member of FIG. 2B joined to the wall section of the quarter round modular wall segment of FIG. 2A.

FIG. 3 is a perspective view of a straight modular wall segment in accordance with the present invention with an inner cylindrical interlock region, an outer cylindrical interlock region, and a magnet in an interlock region.

FIG. 4A is a perspective view of detachably interconnecting round modular wall segments during assembly of a round modular mold in accordance with the present invention.

FIG. 4B is a perspective view of the assembled modular mold of FIG. 4A positioned on a planar baking surface having food product being placed within the assembled round modular mold.

FIG. 5A is a top plan view of an outline of an assembled rectangular modular mold with rounded corners in accordance with the present invention.

FIG. 5B is a top plan view of an outline of an assembled rectangular modular mold with square corners in accordance with the present invention.

FIG. 5C is a top plan view of outline of an assembled specially shaped modular mold in accordance with the present invention.

### DETAILED DESCRIPTION

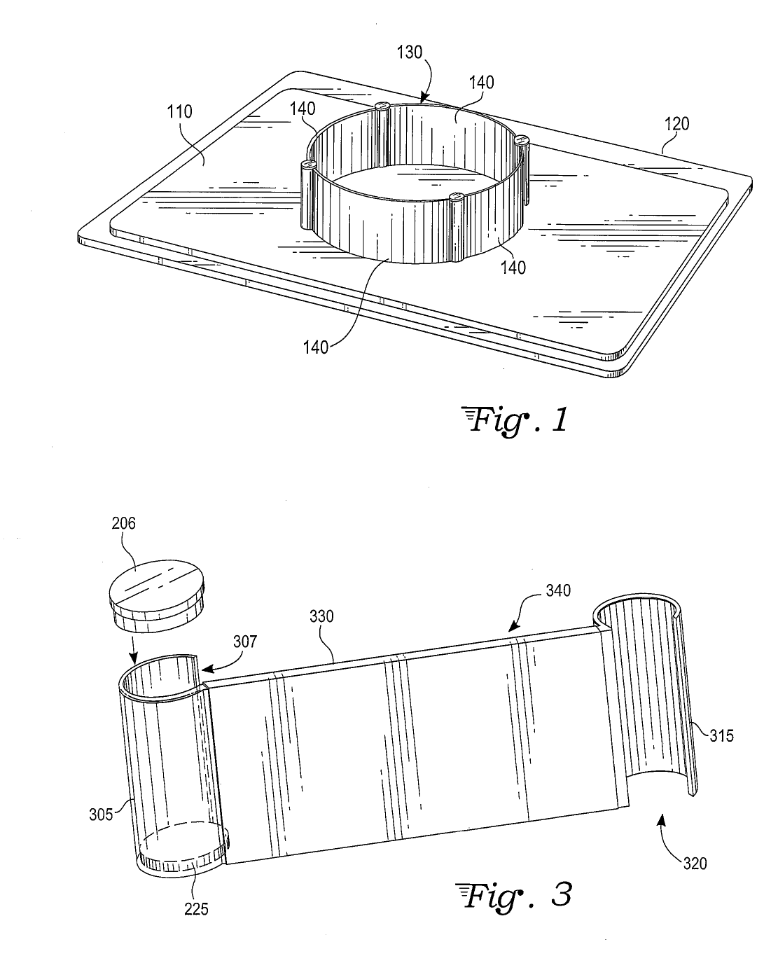

In FIG. 1, a baking structure is constructed by modular wall segments joined together to form round modular mold 130 upon a first planar baking surface 110. The modular wall segments have opposed endwise interlock regions that offer rotational freedom, allowing wall segments to form molds of a selected shape. The first planar baking surface 110 is positioned upon a second planar baking surface 120. The round modular mold 130 is formed by four interlocking quarter round modular wall segments 140. As explained below, the interlock portions of the segments may contain magnets to secure the position of the modular mold to an underlying ferromagnetic second planar baking surface 120 using an intervening separator, namely the first planar baking surface 110 which may be a non-stick silicone baking member to prevent food from leaking underneath modular wall segments. Note that the round modular mold 130 is basically a containment wall formed by only the four round interlocking modular wall segments 140. There is no bottom segment or portion as in conventional baking pans. Round modular wall segments 140 are used for illustrative purposes only. Modular wall segments may be in various shapes, sizes, numbers, lengths, or widths, thus enabling modular molds to be assembled in diverse shapes and sizes.

The quantity and types of planar baking surfaces upon which the round modular mold 130 may be positioned would depend on use of slippage-retaining magnetic containment structures.

A planar baking surface 120 may be rigid or semi-rigid, such as a steel cookie sheet or a sheet pan, which allows the baking structure to be easily moved or placed in and out of an oven. In the embodiment of FIG. 1, planar baking surface 120 is rigid. An intervening planar baking surface 110 may be a type of liner, for example, parchment paper or a silicone baking mat. Various combinations of planar baking surfaces which may be used are discussed below with magnetic slippage-retaining and containment structures

Materials used for making modular wall segments 140 are capable of withstanding standard oven temperatures for preparing and baking the food product and of being nonreactive with the food product at the standard oven temperatures. Such materials for preparing and baking food products are well known in the art and need not be discussed further.

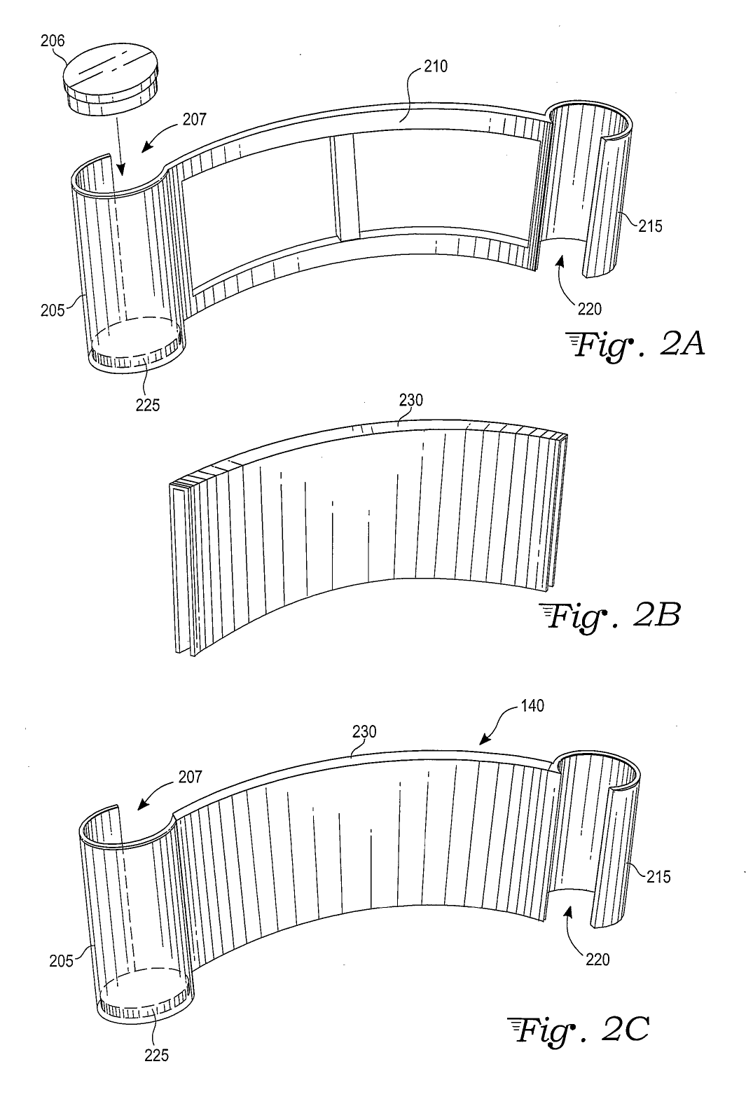

In FIG. 2A, a modular wall segment 210 has an inwardly projecting inner cylindrical interlock 205 and an outwardly projecting outer cylindrical interlock 215. Wall section 210, inner cylindrical interlock 205 and outer cylindrical interlock 215 are unitary and are made from the same material used for modular wall segments 140 as discussed above. Wall section 210 is shown as being arcuate or rounded such as is used in quarter round modular wall segment 140 of FIG. 1. Wall section 210 may also be formed in numerous shapes, sizes, shapes, lengths, or widths as discussed above for modular wall segments thus shaping the modular wall segments and the assembled modular mold 130.

The wall section 210 is shown with an open wall structure but the wall structure may also be fully closed by sheet material. Wall section 210 may also be a nonstick material, coated with a nonstick material, or covered by a nonstick material. Nonstick coatings and coverings are well known in the art. In addition, wall section 210 may be rigid or flexible. Flexible wall sections allow for greater variations in the shape of assembled modular molds.

Inner cylindrical interlock 205 is laterally adjacent to wall section 210 with the height of inner cylindrical interlock region 205 matching the height of wall section 210. The height of inner cylindrical interlock region 205 may vary from the height of wall section 210. The varying heights would limit an amount of food product that may be placed in any assembled modular mold such as assembled modular mold 130 of FIG. 1. Inner cylindrical interlock region 205 is shown with an outwardly facing opening 207, having an axis running the length of inner cylindrical interlock region 205 and near wall section 210. Other embodiments of inner cylindrical interlock region 205 may not have opening 207. Inner cylindrical interlock 205 may have a magnet 225 inserted as shown in FIG. 2C. Magnet 225 is a magnet that retains its magnetic properties at standard oven temperatures for preparing and baking the food product. Magnet 225 serves as a slippage-retarding structure which is discussed below in detail. Magnet 225 may also completely fill inner cylindrical interlock 205. A cap 206 may be inserted into inner cylindrical interlock 205 to prevent the entry of food product into the interlocks. Alternate embodiments entail cap 206 inserted into outer cylindrical interlock 215.

Returning to FIG. 2A, outer cylindrical interlock region 215 is joined laterally to wall section 210 opposite inner cylindrical interlock region 205. Outer cylindrical interlock region 215 is joined to wall section 210 with the height of outer cylindrical interlock region 215 matching the height of wall section 210. The height of outer cylindrical interlock region 215 may vary from the height of wall section 210. The varying heights would limit an amount of food product that may be placed in any assembled modular mold such as assembled modular mold 130 of FIG. 1. Outer cylindrical interlock region 215 is shown with an opening 220, along the straight lateral side, parallel to the axis of the outer cylindrical interlock region 215, running the length of outer cylindrical interlock region 215 and contiguous to wall section 210. Inner cylindrical interlock region 205 and outer cylindrical interlock region 215 may be made from the same materials and with the same coatings or coverings as wall section 210. Preferably the wall section and the interlock regions are unitary. Opening 220 allows for detachable insertion of an inner cylindrical interlock by coaxial nesting into an outer cylindrical interlock and provides rotational freedom between the modular wall segments that have been detachably interconnected in this manner. The rotational freedom also extends to an assembled modular mold such as assembled modular mold 130 of FIG. 1. As an example, shape of modular mold 130 may be varied, without disassembly or reassembly, between a circle and an oval merely by pressing or pulling on opposite modular wall segments 140.

In FIG. 2B containment structure 230 is a nonstick silicone baking material that slips over wall section 210 of FIG. 2A as a sheath. The sheath material is a non-stick envelope that is disposable and replaceable. In alternate embodiments containment structure 230 may be a nonstick silicone baking material that is molded or cast over wall section 210 thereby becoming a nonremovable, reusable non-stick containment structure. It is not necessary to use a containment structure where the wall section 210 has no openings and provides containment.

FIG. 2C illustrates both a completely unitary wall structure of the type shown in FIG. 1 (or the open wall embodiment of FIG. 2A with the containment structure 230 of FIG. 2B.)

Modular wall segment 140 has a slippage-retarding structure. Magnet 225 impedes slippage between modular wall segment 140 and an underlying ferromagnetic planar baking surface, such as planar baking surface 120 of FIG. 1. The magnet 225 is attracted to the ferromagnetic planar baking surface 120 thereby impeding slippage of modular wall segment 140, and hence modular mold 130, with respect to the ferromagnetic planar baking surface. When both planar surfaces 110 and 120 are used, the magnet 225 is attracted to planar baking surface 120, which is ferromagnetic, impeding slippage with respect to modular wall segment 140 and planar baking surface 120. Planar baking surface 110, a type of liner, is entrapped between planar baking surface 120 and modular wall segment 140 thereby impeding slippage with respect to planar baking surface 110.

Another embodiment of a slippage-retarding structure may be a non-skid surface applied to the bottom of modular wall segment 140 thus impeding slippage between modular wall segment 140, and hence modular mold 130, with respect to planar baking surfaces 110 or 120 with which it is in direct contact. Modular mold 130 may be placed directly onto planar baking surface 120, which is rigid, and the non-skid material impedes slippage between modular mold 130 and planar baking surface 120. When planar baking surface 110, a type of liner, is used in conjunction with a rigid planar baking surface 120, planar baking surface 110 may be a non-stick silicone baking material. The non-stick silicone baking material of planar baking surface 110 has enough friction between it and both the non-skid surface applied to the bottom of modular wall segment 340 and rigid planar baking surface 120 to impede slippage between all three.

Another embodiment may use both magnet 225 and the non-skid surface applied to the bottom of modular wall segment 340 as slippage-retarding structures. The magnet may be disk shaped, like a pill, or may be rod shaped. The magnet 225 may occupy the cylindrical interior of the region of the inner or outer interlock regions. The slippage-retarding structures may also function as containment structures impeding leakage of the food product between the assembled modular mold 130 and the planar baking surface, either 110 or 120, upon which the assembled modular mold 130 is directly positioned. This occurs because the magnet prevents food product leaking into the interlock regions.

The outer diameter of inner cylindrical interlock 205 is a first diameter. The inner diameter of outer cylindrical interlock 215 is a second diameter. One diameter is slightly smaller than the other diameter. All inner cylindrical interlocks have the same outer diameter. All outer cylindrical interlocks have the same inner diameter. This standardization of first and second diameters allows one type of cylindrical interlock of a modular wall segment to coaxially nest in the other type of cylindrical interlock and provide rotational freedom between the detachably connected modular wall segments. This standardization also of first and second diameters also allows cap 206 to be standardized an able to be inserted into any inner cylindrical interlock or any outer cylindrical interlock. In alternate embodiments wall section 210 may be joined to interlocks that are not cylindrical, i.e., not rounded. Instead of being rounded, interlocks joined to wall section 210 may be based on other geometric forms, for example, octagonal, decagonal, dodecahedral, etc., so long as there are nesting interlocking members. An opening, similar to opening 220 is required and the interlocks are detachably inserted into one another to detachably interconnect modular wall segments. Appropriately shaped caps may be inserted into either inner or outer interlocks. Other geometric forms allow the modular wall segments to be detachably interconnected at various angles. Other geometric forms with a greater number of sides allow for a greater number of angles at which the modular segments may be detachably interconnected.

In FIG. 3 the modular wall segment is straight. As noted above, modular wall segments may be in numerous shapes, sizes, shapes, lengths, or widths thus enabling modular molds to be assembled in a wide variety of shapes and sizes. Straight wall segments may be combined with curved wall segments. Interlock regions, magnets, and caps etc. are the same as previously described.

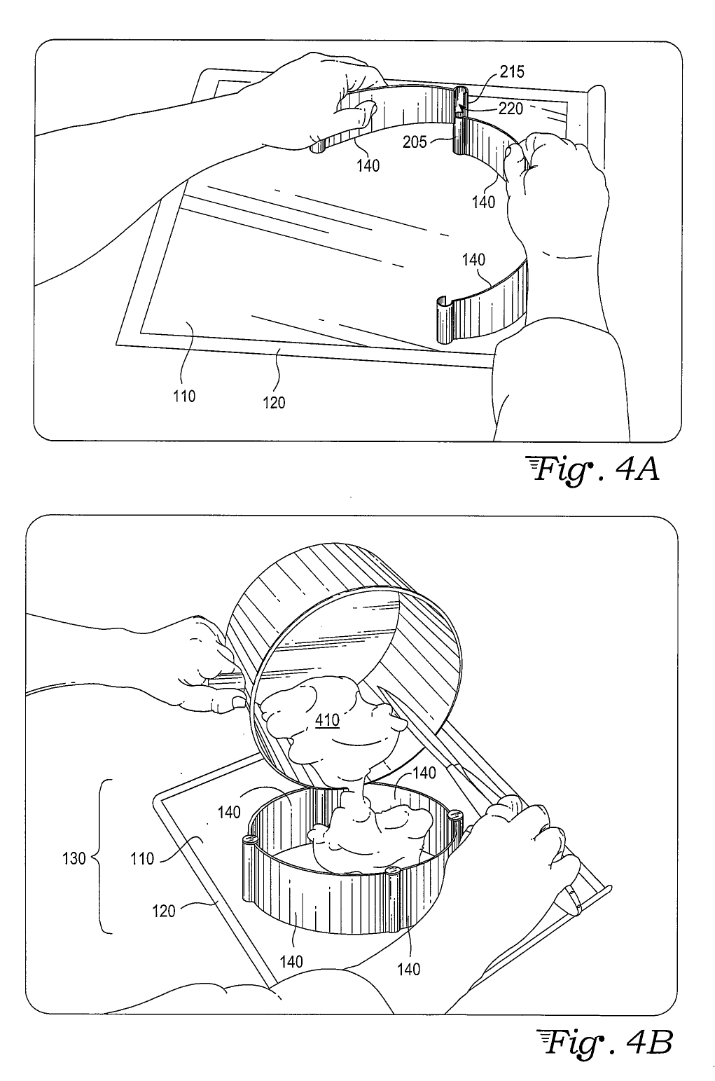

In FIG. 4A detachably interconnecting quarter round modular wall segments 140 are assembled to form the round modular mold 130 of FIG. 1. Outer cylindrical interlock 215, along with its accompanying modular wall segment 140, is lifted onto inner cylindrical interlock 205 and pushed down towards planar baking surfaces 110 and 120, resulting in inner cylindrical interlock 205 being detachably inserted into outer cylindrical interlock 215 through opening 220 thereby detachably interconnecting the respective modular wall segments 140. This process continues until assembly of a modular mold is completed. The rotational freedom described above is available to the modular wall segments 140 and the fully assembled modular mold.

FIG. 4B illustrates food product 410 being disposed into assembled round modular mold 130 which is positioned on planar baking surfaces 110 and 120. Round modular mold 130 is assembled from four quarter round modular wall segments 140. The baking structure consisting of the assembled round modular mold 130 and planar baking structures 110 and 120, along with the disposed food product 410 may then placed in an oven and baked.

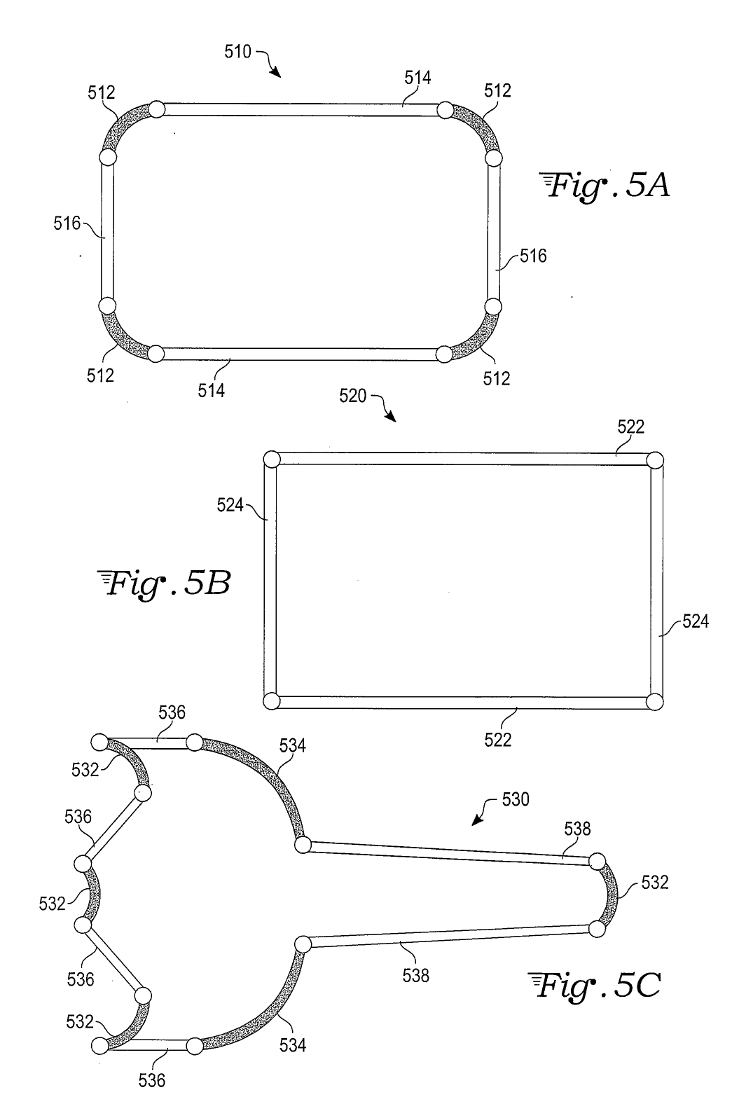

In FIGS. 5A, 5B, and 5C diverse shapes and sizes of modular wall segments of the present invention are used to make modular molds.

In particular, in FIG. 5A, an assembled rectangular modular mold 510 with rounded corners in shown. Assembled rectangular modular mold 510 is assembled with three types of modular wall segments. The first type of modular wall segments is straight modular wall segment 510 of which there are two. The second type of modular wall segment is straight modular wall segment 516 of which there are two. Straight modular wall segment 510 is longer than straight modular wall segment 516. The third type of modular wall segment is quarter round modular wall segment 512 of which there are four.

In FIG. 5B an assembled rectangular modular mold 520 has square corners. Assembled rectangular modular mold 520 is assembled with two types of modular wall segments, straight modular wall segment 522 of which there are two, and straight modular wall segment 524 of which there are two. Modular wall segments 522 are shown to be longer than modular wall segments 524.

In FIG. 5C an assembled specially shaped modular mold 530 may be described, among other things, as a guitar, a space ship, a tulip, a stemmed champagne glass, etc. The complex shape of specially shaped modular mold 530 is assembled from four types of modular wall segments. Two of the four types are straight modular wall segments 536 and 538 where straight modular wall segment 536 is shorter than straight modular wall segment 538. The other two of the four types are quarter round modular wall segments 532 and 534 where quarter round modular wall segment 532 is smaller, e.g., has a shorter radius, than quarter round modular wall segment 534.

What is claimed is:

1. A mold for baking a food product comprising:
a plurality of oven temperature stable modular wall segments having opposed endwise interlock regions able to interlockingly form a closed food containment wall on a planar surface, the interlocks being an inner interlock and an outer interlock shaped such that the inner interlock of a first modular wall segment is operably and detachably coaxially interconnectable by nesting with the outer interlock of a second modular wall segment; and
a slippage-retarding structure associated with the modular wall segments to impede sliding and reshaping of an assembled modular mold on the planar surface.

2. The modular mold of claim 1 wherein the inner interlock and the outer interlock are hollow cylindrical members.

3. The apparatus of claim 1 wherein one of the inner and outer cylindrical interlocks has a greater diameter than the other for coaxial engagement of one interlock nested within the other with rotational freedom provided between the engaged inner cylindrical interlock and the outer cylindrical interlock thereby enabling the assembled modular wall segments to form various mold shapes.

4. The apparatus of claim 1 wherein the slippage-retarding structure comprises magnets inserted into one of the inner and outer cylindrical interlocks.

5. The apparatus of claim 4 wherein the magnets are disk shaped.

6. The apparatus of claim 1 wherein the modular wall segments have a nonstick wall surface.

7. The apparatus of claim 1 wherein the slippage-retarding structure comprises a nonskid surface on the bottom of the modular wall segments.

8. The apparatus of claim 1 wherein the wall sections of the modular wall segment are selected from curved, straight, and other shaped segments.

9. The apparatus of claim 1 wherein the containment structure is a nonstick silicone baking material covering the wall section.

10. The apparatus of claim 1 wherein the wall section is rigid.

11. The apparatus of claim 1 wherein the wall section is flexible.

12. A modular mold for baking a food product, the modular mold comprising:
modular wall segments having endwise hollow inner and outer coaxially nesting cylindrical interlocks able to operably and detachably interconnect to form a modular mold, with rotational freedom between the inner cylindrical interlock and the outer cylindrical interlock enabling an assembled modular mold to form a selected geometric shape;
magnets inserted into one of the inner and outer cylindrical interlocks; and
a ferromagnetic surface supporting the modular wall segments.
